(19) United States
(12) Patent Application Publication
(10) Pub. No.: US 2024/0364806 A1
(43) Pub. Date: Oct. 31, 2024

(54) DISPLAYING RELEVANT USER INTERFACE OBJECTS

(71) Applicant: Apple Inc., Cupertino, CA (US)

(72) Inventors: Gary Ian BUTCHER, Los Gatos, CA (US); Imran CHAUDHRI, San Francisco, CA (US); Jonathan R. DASCOLA, San Francisco, CA (US); Alan C. DYE, San Francisco, CA (US); Christopher Patrick FOSS, San Francisco, CA (US); Daniel C. GROSS, San Francisco, CA (US); Chanaka G. KARUNAMUNI, San Jose, CA (US); Stephen O. LEMAY, Palo Alto, CA (US); Natalia MARIC, San Francisco, CA (US); Christopher WILSON, Sonoma, CA (US); Lawrence Y. YANG, Bellevue, WA (US)

(21) Appl. No.: 18/764,748

(22) Filed: Jul. 5, 2024

Related U.S. Application Data
(63) Continuation of application No. 17/728,725, filed on Apr. 25, 2022, now Pat. No. 12,088,755.
Application No. 17/728,725 is a continuation of application No. 17/190,869, filed on Mar. 3, 2021, now Pat. No. 11,316,968.
Application No. 17/190,869 is a continuation of application No. 16/267,817, filed on Feb. 5, 2019, now Pat. No. 10,972,600.
Application No. 16/267,817 is a continuation of application No. 15/033,551, filed on Apr. 29, 2016, now Pat. No. 10,250,735.

(51) Int. Cl. H04M 1/72454; G06F 1/16; G06F 3/01; G06F 3/0346; G06F 3/0362; G06F 3/04817; G06F 3/0482; G06F 3/0488; G06F 3/04883; H04M 1/72457

(52) U.S. Cl. CPC H04M 1/72454; G06F 1/163; G06F 1/1694; G06F 3/015; G06F 3/017; G06F 3/0346; G06F 3/0362; G06F 3/04817; G06F 3/0482; G06F 3/0488; G06F 3/04883; H04M 1/72457; H04M 2250/10; H04M 2250/12

(57) ABSTRACT

Techniques for displaying relevant user interface objects when a device is placed into viewing position are disclosed. In one example, the device displays a user interface including a plurality of application icons. While displaying the user interface including the plurality of application icons, the device detects rotation of a rotatable input mechanism and in response, replaces display of the user interface including the plurality of application icons with a representation of a physical location.

### CROSS-REFERENCE TO RELATED APPLICATIONS

This application is a continuation of U.S. application Ser. No. 17/728,725, filed Apr. 25, 2022, titled “DISPLAYING RELEVANT USER INTERFACE OBJECTS,” which is a continuation of U.S. application Ser. No. 17/190,869, titled “DISPLAYING RELEVANT USER INTERFACE OBJECTS,” filed Mar. 3, 2021 (now U.S. Pat. No. 11,316,968), which is a continuation of U.S. application Ser. No. 16/267,817, filed on Feb. 5, 2019, titled “DISPLAYING RELEVANT USER INTERFACE OBJECTS,” (now U.S. Pat. No. 10,972,600), which is a continuation of U.S. application Ser. No. 15/033,551, filed on Apr. 29, 2016, titled “DISPLAYING RELEVANT USER INTERFACE OBJECTS,” (now U.S. Pat. No. 10,250,735), which is a national stage application under 35 U.S.C. § 371 of International Patent Application No. PCT/US2013/067634, filed on Oct. 30, 2013, titled “DISPLAYING RELEVANT USER INTERFACE OBJECTS,” the contents of each of which are hereby incorporated by reference.

### FIELD

The disclosed embodiments relate generally to user interfaces of electronic devices.

### BACKGROUND

Advanced personal electronic devices can have small form factors. Exemplary personal electronic devices include but are not limited to tablets and smart phones. Uses of such personal electronic devices involve presentation and manipulation of user interface objects on display screens that are designed to be small to complement the personal electronic devices.

Exemplary user interface objects include digital images, video, text, icons, control elements such as buttons, and other graphics. As used here, the term icon refers to an image that is used to represent and to launch an application, consistent with its ordinary meaning in the art. In addition, a “widget,” which is used in the art to refer to a simplified view of an application, constitutes an icon, for purposes of this disclosure.

Existing user interfaces on reduced-size personal electronic devices can be inefficient, as they may require multiple manipulations by a user before appropriate information is presented.

### SUMMARY

Techniques for presenting user interface objects on a personal electronics device are disclosed.

### DESCRIPTION OF THE FIGURES

FIG. 1 illustrates an exemplary personal electronic device.

FIG. 2 illustrates an exemplary user interface.

FIG. 3 illustrates an exemplary user interface.

FIG. 4 illustrates an exemplary logical structure of a user interface.

FIG. 5 illustrates an exemplary user interface.

FIG. 6 illustrates an exemplary user interface.

FIG. 7 illustrates an exemplary computing system.

FIG. 8 illustrates an exemplary user interface.

FIG. 9 illustrates an exemplary user interface.

FIG. 10 illustrates an exemplary user interface.

FIG. 11 illustrates an exemplary user interface.

FIG. 12 illustrates an exemplary user interface.

FIG. 13 illustrates an exemplary user interface.

FIG. 14 illustrates an exemplary user interface.

FIG. 15 illustrates an exemplary user interface.

FIG. 16 illustrates an exemplary user interface.

FIG. 17 illustrates an exemplary user interface.

FIG. 18 illustrates an exemplary process for displaying user interface objects.

### DETAILED DESCRIPTION

In the following description of the disclosure and examples, reference is made to the accompanying drawings in which it is shown by way of illustration specific examples that can be practiced. It is to be understood that other examples can be practiced and structural changes can be made without departing from the scope of the disclosure.

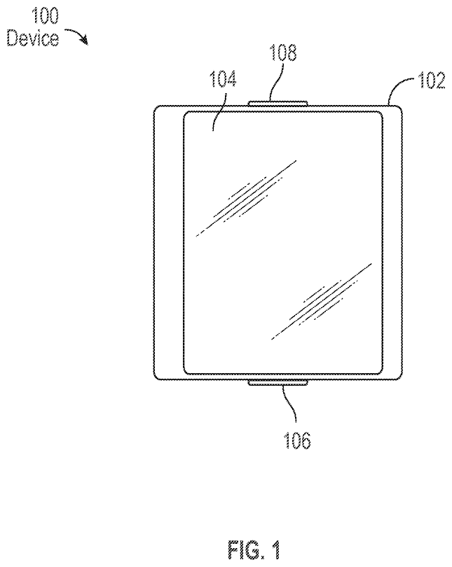

FIG. 1 illustrates exemplary personal electronic device 100 (hereafter device 100). In the illustrated example, device 100 includes body 102. Device 100 can have touch-sensitive display screen (hereafter touchscreen) 104.

Touchscreen 104 can include a display device, such as a liquid crystal display (LCD), light-emitting diode (LED) display, organic light-emitting diode (OLED) display, or the like, positioned partially or fully behind or in front of a touch sensor panel implemented using any desired touch sensing technology, such as mutual-capacitance touch sensing, self-capacitance touch sensing, resistive touch sensing, projection scan touch sensing, or the like. Touchscreen 104 can allow a user to perform various functions by touching over hovering near the touch sensor panel using one or more fingers or other object.

In some embodiments, device 100 can have one or more input mechanisms 106 and 108. Input mechanisms 106 and 108, if included, can be touch-sensitive. Examples of touch-sensitive input mechanisms include touch-sensitive buttons and touch-sensitive surfaces. Input mechanisms 106 and 108, if included, can be physical. Examples of physical input mechanisms include push buttons and rotatable mechanisms. Body 102, which can include a bezel, can have predetermined regions on the bezel that act as input mechanisms. In some embodiments, device 100 can have an attachment mechanism. Such an attachment mechanism, if included, can permit attachment of device 100 with clothing, jewelry, and other wearable accessories, for example. For example, the attachment mechanism can attach to hats, eyewear, earrings, necklaces, shirts, jackets, bracelets, watch straps, chains, trousers, belts, shoes, purses, backpacks, so forth.

In some embodiments, device 100 can have one or more pressure sensors (not shown) for detecting a force or pressure applied to touchscreen 104. The force or pressure applied to touchscreen 104 can be used as an input to device 100 to perform any desired operation, such as making a selection, entering or exiting a menu, causing the display of additional options/actions, or the like. Different operations can be performed based on the amount of force or pressure being applied to touchscreen 104. The one or more pressure sensors can further be used to determine a position that the force is being applied to touchscreen 104.

### 1. Displaying Relevant User Interface Objects

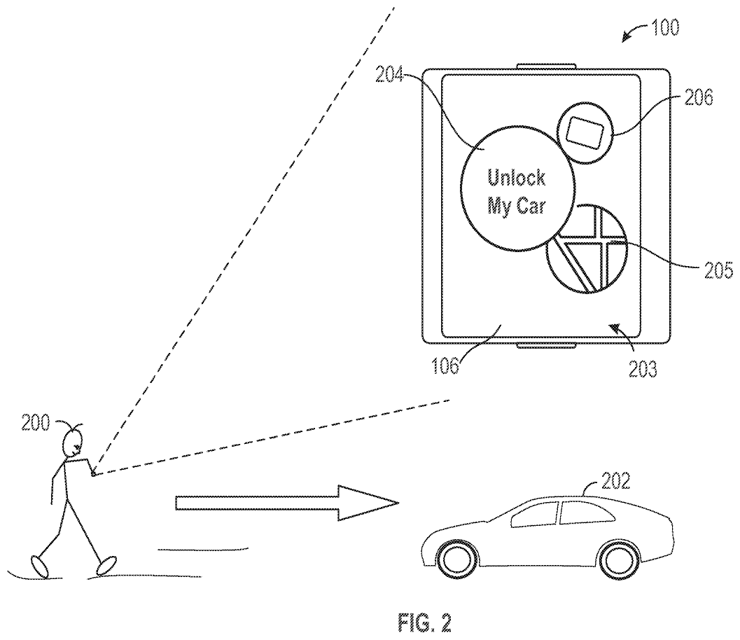

FIG. 2 illustrates exemplary device 100 worn by user 201, who is walking towards his vehicle 202. As user 201 moves device 100 into a viewing position, device 100 displays a user interface screen 203 on touchscreen 104, automatically. In some embodiments, the display elements of touchscreen 104 are inactive until user 201 moves device 100 into viewing position, meaning that the display elements of touchscreen 104 are off or appear to be off. In some embodiments, device 100 can rotate the displayed contents of touchscreen 104 (e.g., between landscape and portrait modes) so that the displayed information is in a proper viewing orientation, regardless of whether device 100 is held upwards, downwards, or sideways by user 201.

User interface screen 203 includes user interface objects that device 100 has determined to be the most relevant to the user this moment. In particular, screen 203 includes an icon 204 for unlocking vehicle 202, which is useful to user 201 as he approaches his vehicle. Screen 203 also includes map icon 205 for accessing traffic information, which can be useful to user 201 as he begins his trip. Screen 203 also includes icon 206 referencing an upcoming calendar event, which can be useful in providing destination information. Sizes of displayed icons can be relative to their relevance. On screen 203, icon 204 is larger than icons 205 and 206 because device 100 has concluded that the unlocking of vehicle 202, provided via icon 204, is more relevant.

This user interface presentation is notable in that it prioritizes and displays a manageable subset of icons to user 201, even if many more user interface objects are available for display. Also, this user interface is made available to user 201 without any user interface navigation input from the user, other than the raising of his arm (e.g., without requiring user 201 to push a power-on or equivalent button). In this way, device 100 reduces the amount of user input required to invoke an appropriate user interface action. This benefit is non-trivial, particularly because device 100 has a relatively small display screen size, as compared with smart phones and other electronic devices, which can impede a user's navigation of a larger user interface environment.

It is possible for the number of relevant user interface objects in a given situation to exceed the number that can be reasonably displayed together on touchscreen 104, such as three as shown in FIG. 2. When this is the case, device 100 can prioritize the most relevant icons—as determined by a computer-based relevance algorithm on device 100—for initial display. In some embodiments, a user can bring the remaining relevant icons onto the display using input mechanisms 106 or 108. In some embodiments, a user can bring the remaining relevant icons onto the display using touchscreen 104, such as by swiping touchscreen 104 with a touch object.

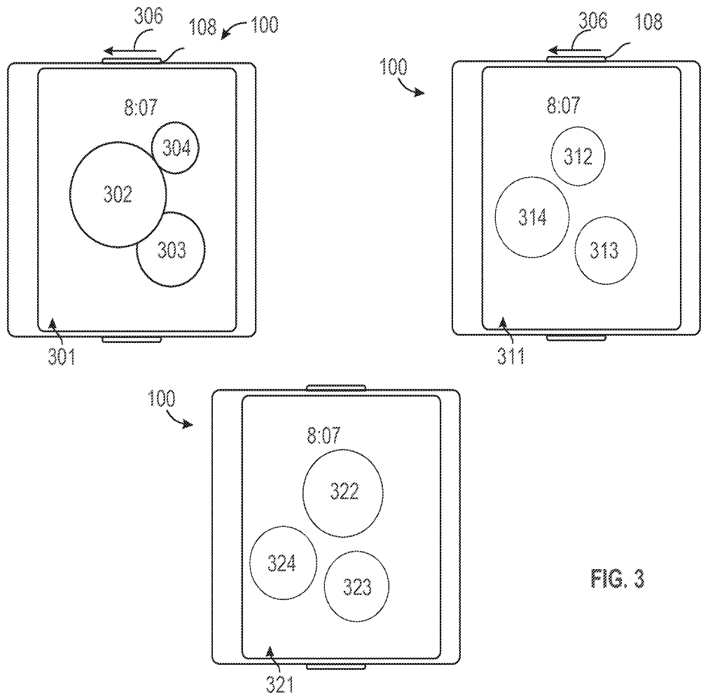

FIG. 3 illustrates the display of relevant icons over multiple user interface screens. In the illustrated example, user interface screen 301 was displayed on device 100 in response to an upward movement of the device. Screen 301 includes icons 302-304 representing relevant applications, which can be icons 203-205 (FIG. 2) in some examples. In response to a rotation of input mechanism 108 in direction 306, user interface screen 311 becomes displayed on device 100. Screen 311 can show a number of additional relevant icons 312-314 that are less relevant than those shown in screen 301. In a response to a further rotation of input mechanism 108 in the same direction 306, device 100 can show user interface screen 321. Screen 321 can include another set of relevant icons 322-324 that are less relevant than those shown in screen 311, which are in turn less relevant than those in screen 301. Input mechanism 108 can be a rotatable crown. In this way, a user can navigate between multiple sets of relevant user interface objects (e.g., icons) on device 100.

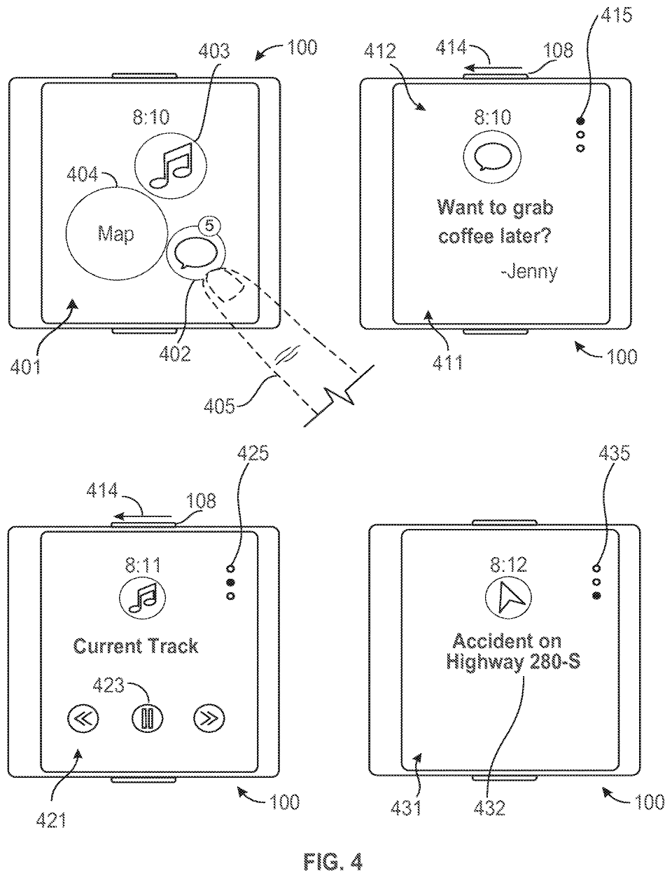

A user can launch an application that corresponds to a displayed icon by touching (e.g., via a finger tap) the displayed icon. As used here, the launching of an application means that the application runs in the foreground of device 100 and is shown on-screen. FIG. 4 illustrates this aspect. In the illustrated example, user interface screen 401 was displayed on device 100 in response to a movement of the device into viewing position. Screen 401 includes icon 402 representing a messaging application (e.g., supporting Short Message Service (SMS)) having five unread messages, as well as icons 403 and 404 representing other applications. In response to a tap on icon 402 from a touch object (e.g., finger 405), device 100 launches the corresponding messaging application and displays unread messages 412 on user interface screen 411.

Under some usage conditions, a user may wish to navigate from the messaging application to another relevant application. For instance, the user may wish to navigate to the music and map applications previously represented by icons 403 and 404 on screen 401. Device 100 can permit navigation between these applications directly, without first returning to screen 401. In particular, a rotation of input mechanism 108 in direction 414 while screen 411 is displayed causes device 100 to display the music player represented by icon 403 on screen 421. Screen 421 can include music playback controls 423. A further rotation of input mechanism 108 in direction 414 while screen 421 is displayed causes device 100 to display the map application represented by icon 404 on screen 431. Screen 431 can include traffic information 432.

In some embodiments, screens 411, 421, and 431 include visual aids, such as paging dots 415, 425, and 435, respectively, that identify the relative position of the currently displayed application along the sequence of applications accessible via input mechanism 108. Other visual aids, such as scroll bars and screen-to-screen transitions, can also be used to aid the user's identification of the currently displayed user interface screen in relation to the larger set of available user interface screens.

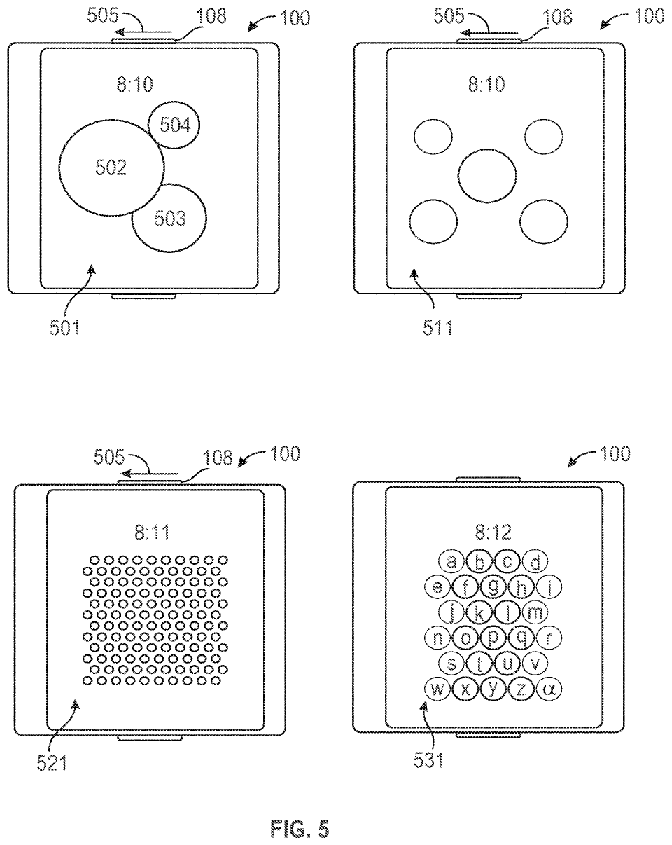

While the exemplary user interface screens depicted in FIGS. 2-4 are primarily concerned with the efficient display of relevant user interface objects, it should be noted that device 100 can include many more user interface objects that should be accessible to a user, even if their relevance in the moment is not readily discernible. For example, a user may wish to play a game impulsively. Device 100 can permit user navigation beyond relevant user interface objects to other user interface objects. FIG. 5 illustrates this aspect.

In FIG. 5, user interface screen 501 is displayed on device 100 in response to movement of the device into viewing position. Screen 501 includes icons 502-504 representing relevant applications, which can be icons 203-205 (FIG. 2) in some examples. In the illustrated example, device 100 has determined that only three user interface objects (i.e., icons 502-504) are relevant at the moment. Thus, in response to a rotation of input mechanism 108 in direction 505, device 100 displays user interface screen 511 having other user interface objects available for user selection on device 100. The icons shown on screen 511 can be a user's favorite icons, meaning that the icons of screen 511 are a predetermined subset of user interface objects available on device 100. In response to a further rotation of input mechanism 108 in direction 505, device 100 displays user interface screen 521, which includes icons that represent all of the available applications on device 100. Because the size of the displayed icons on screen 521 may be too small for user navigation, in response to a further rotation of input mechanism 108 in direction 505, device 100 displays screen 531, which has the effect of zooming into a subset of the icons from screen 521 so that those icons are displayed in larger size for user interaction.

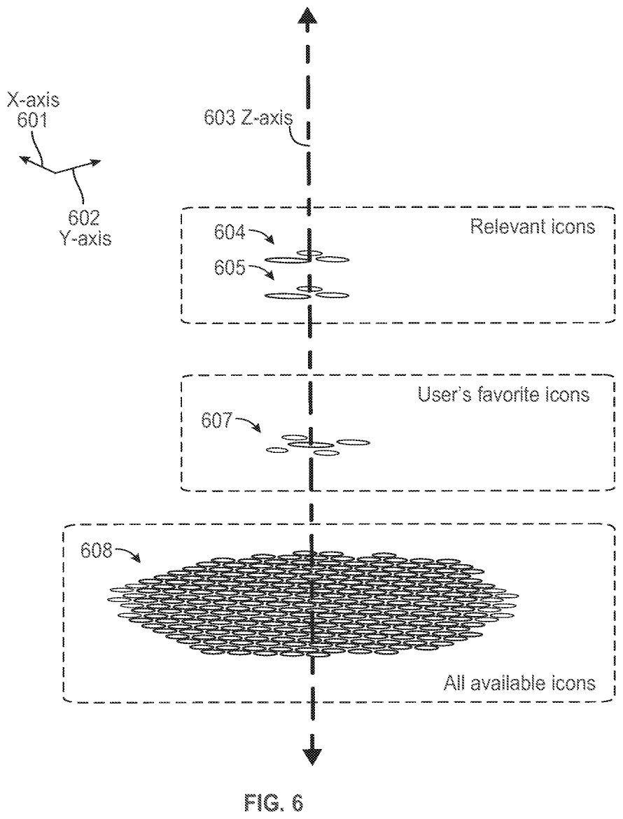

The user interface navigation described with reference to FIG. 5 can be logically organized according to logical structure 600 depicted in FIG. 6. In the illustrated example of FIG. 6, x-axis 601 and y-axis 602 form a plane co-planar with the touchscreen screen surface of device 100 (FIG. 1), and z-axis 603 is perpendicular to the x/y-plane formed by axes 601 and 602. Plane 604, in one example, corresponds to user interface screen 501 (FIG. 5), while plane 605 corresponds to user interface screen 511 (FIG. 5), and plane 607 corresponds to user interface screens 521 and 531 (FIG. 5). More specifically, screen 521 (FIG. 5) can correspond to a viewpoint of the entire content of plane 607, while screen 531 (FIG. 5) can correspond to a zoomed in viewpoint (i.e., an enlarged subset) of the content of plane 607. In another example, planes 604, 607, 608 can correspond to user interface screens 301, 311, and 321 of FIG. 3, respectively. Movement of an input mechanism can be used to select a particular plane of information (i.e., screen of icons) for display on device 100. For example, rotation of input mechanism 108 can cause different screens of icons to be displayed on device 100 similar to the fashion depicted in FIG. 5, for example.

### 2. Determining Relevant User Interface Objects

Consistent with its plain meaning, the phrase “relevant icons” is used here to refer to user interface icons that bear upon or properly apply to the matter that is at hand. In the example of FIG. 2, an icon for unlocking a vehicle application is relevant as a user draws near his car, because the user is likely to want to drive the car. Device 100 can determine relevance using computer instructions (e.g., algorithms) that account for different inputs, including sensor input, application data, and operating system data.

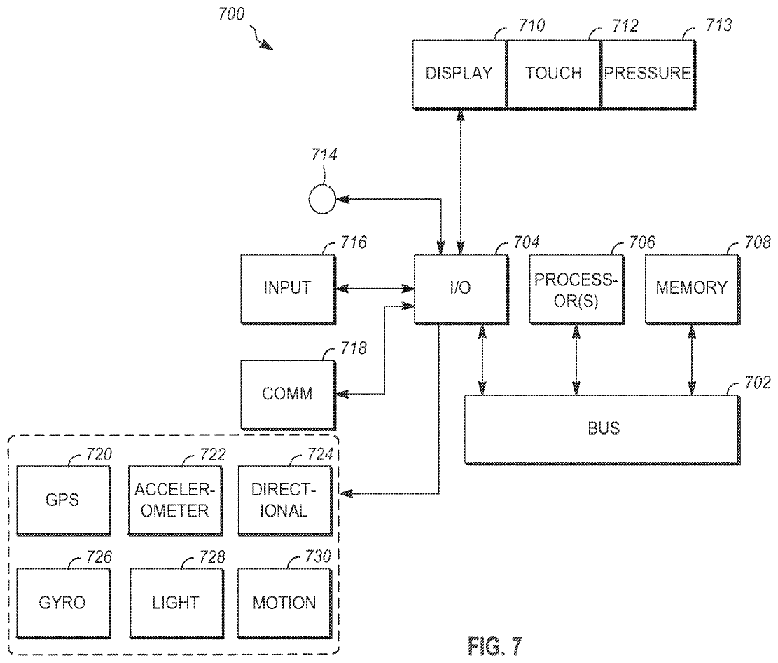

FIG. 7 depicts exemplary computing system 700 that, in some embodiments, form device 100. Computing 700 includes components for determining and displaying relevant user interface objects. In the illustrated example, computing system 700 includes an I/O section 704 that can be operatively coupled (connected) with various sensors, such as GPS sensor 720, accelerometer 722, directional sensor 724, gyroscope 726, light sensor 728, and/or a combination thereof. I/O section 704 also can be connected with communication unit 718, for receiving application and operating system data, over Wi-Fi, Bluetooth™, near-field communication (“NFC”), cellular and other wireless communication techniques. In addition, computing system 700 can have bus 702 that connects I/O section 704 together with one or more computer processors 706 and memory section 708. Memory section 708 can contain computer-executable instructions (e.g., representing algorithms) and/or data for determining and displaying relevant user interface objects. One or more of these components can be part of an integrated chip or a so-called system-on-a-chip. In addition, I/O section 704 can be connected to input mechanism 714. I/O section 704 can be connected to one or more input buttons 716. I/O section 704 can be connected to display 710, which can have touch-sensitive component 712 and, optionally, touch-pressure sensitive component 713.

The sensors and communication units of computing system 700 can provide information for identifying relevant user interface objects. For example, GPS sensor 720 can determine a user's location and movement while communication unit 718 can receive information about the location and identity of a nearby vehicle (e.g., vehicle 202 in FIG. 2). Accelerometer 722, directional sensor 724, and gyroscope 726 can further detect device movement. Optionally, the outputs of GPS sensor 720, accelerometer 722, directional sensor 724, and/or gyroscope 726 can be interpreted by motion processor 730. Processors 706 and computer-executable instructions in memory section 708 can use some or all of this information to determine that the user is approaching his vehicle. Processors 706 and instructions in memory 708 can also determine, based on application data and/or operating system data (including meta-data) stored in memory 708, that an application for interacting with the user's vehicle is installed. In this way, the relevance algorithms of device 100 can conclude that the vehicle interaction application is relevant to the user in the moment. In addition, device 100 can also conclude, based on the same data, that a map application would also be relevant to the user.

Communication unit 718 can also receive other information that affects the relevance of user interface objects. For example, the communication unit can detect nearby devices that are identical or similar, such as other wearable devices of the same design. The communication unit can also detect non-identical units that are running the same operating system as device 100, such as smart phones and tablets of the same brand. The communication unit can also identify dissimilar devices that support communication over a common protocol. These protocols can include wireless protocols such as Wi-Fi, Bluetooth™, NFC, and the like. These protocols can also be software-based service protocols, such as operating environment service protocols (Apple™ AirPlay™ and AirDrop™), home automation service protocols (e.g., those offered by Phillips™ Lighting and Nest™), authentication service protocols (e.g., airport clearance and metro fares), to point of sale service protocols (e.g., at grocery checkouts), for example. The algorithms used by device 100 to identify relevant user interface objects can account for these inputs provided by the communication unit 718.

Furthermore, communication unit 718 can receive application and operating system data that inform relevance. For example, a messaging application can receive an incoming message via SMS or Wi-Fi service, and thereby become relevant. As another example, the relevance algorithms of device 100 can use calendar data and the cellular system time to determine that an event reminder is relevant. Furthermore, the relevance algorithms of device 100 can consider the content of application and operating system data in determining relevance. For example, the algorithms can consider an incoming message that contains a reference to a specific time (e.g., “let's meet at 3:00 p”) to be increasingly relevant as that time (i.e., 3:00 pm) approaches.

In some embodiments, user interface objects can be relevant in groups. That is, application data (including meta-data) can specify that whenever user interface object A is relevant, that user interface object B is also relevant. For example, a music application can be tied to a vehicle interaction application in this way, because drivers typically enjoy music. A map application can also be tied to a vehicle interaction application in this way, because drivers typically desire traffic and/or routing information.

In some embodiments, relevance algorithms used by device 100 can be adaptive, meaning that the outcome of the algorithms can change based on historical user behavior. For example, the algorithms can recognize a user's work commute based on the user's driving pattern during weekday mornings. In this way, device 100 can prioritize specific traffic information for display in the morning. As another example, if a user repeatedly launches one particular radio application over other available radio applications during his commute, device 100 can identify that radio application as being more relevant, and display its icon whenever the user unlocks his car.

In some embodiments, computing system 700 can include biometric sensors such as health-related sensors such as photoplethysmograph (PPG) sensors, electrocardiography (ECG) sensors, and/or galvanic skin response (GSR) sensors. Device 100 can receive input from one or more of these sensors to provide health-related information. For example, device 100 can use PPG sensor information to alert a user to abnormal respiratory rate, blood pressure, and/or oxygen saturation. As another example, device 100 can use an ECG sensor to alert a user to irregular heartbeats. As yet another example, device 100 can use a GSR sensor to detect a user's skin moisture indicative of sweating, and prioritize a thermostat application for display on device 100. These sensors can also be used to facilitate biometric identification and authentication of a user.

The sensors of computing system 700 can detect when the system (e.g., device 100) is placed into a viewing position. For example, accelerometer 722 and/or motion sensor 730 can detect when computing system 700 is raised, lowered, and shaken. These sensors can also detect wrist rotation forward and backward. In some embodiments, the raising of computing device 700 is interpreted as a placement of the device into viewing position. In some embodiment, the raising and rotation of computing device 700 is interpreted as a placement of the device into viewing position. In some embodiments, the time duration between the raising and lowering of computing device 700 is interpreted as a placement of the device into viewing position.

Algorithms used by device 100 to identify relevant user interface objects for display can use one or more of the above-described aspects of the device (e.g., computing system 700). That is, the algorithms can consider a combination of inputs in determining relevance, including location, movement (including orientation, direction, tilt, acceleration, and velocity), ambient conditions (including light, time, temperature, user's health status), application data (including incoming calls, incoming messages, upcoming calendar events).

For example, device 100 can determine that when it is moving at a velocity that exceeds a threshold (e.g., 10 mph, 20 mph, 25 mph, 30 mph, 40 mph, 50 mph, 55 mph, 60 mph, 65 mph, so forth), the user of the device is commuting, and that icons corresponding to navigational applications have higher relevance. In this situation, device 100 can also determine that icons representing in-vehicle entertainment applications are relevant, if an available in-vehicle device is in communication with the communication unit of device 100. As another example, device 100 can determine that when its biometric sensors and motion sensors detect movement indicative of exercising, icons representing health-related applications have higher relevance. As another example, device 100 can determine that a calendar event that is coming up in a particular amount of time (e.g., 15 minutes, 30 minutes, 1 hour, 1 day, 1 week, so forth) is of higher relevance. Optionally, device 100 can factor in other variables, such as the distance between the device's current location and the event's location, as well as the current weather, in determining the relevance of an event. That is, device 100 may determine that a nearby event that is upcoming in 15 minutes has less relevance than an event that is upcoming in an hour but is 30 miles away, for example.

### 3. Exemplary User Interactions

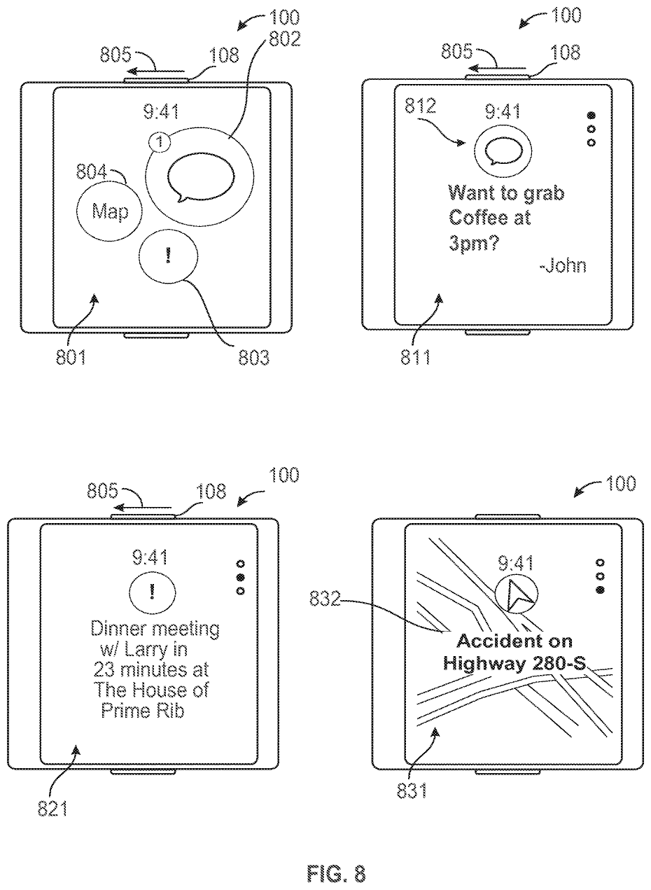

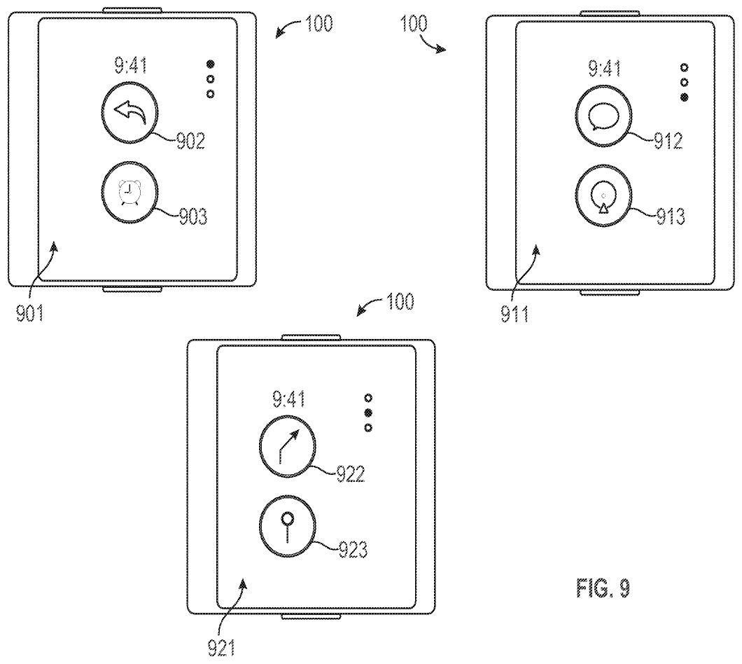

A user can interact with the user interface of device 100. These interactions can include shortcuts for invoking applications features. This aspect is discussed with reference to FIGS. 8-9.

In the example of FIG. 8, device 100 had just received an incoming SMS message, and had provided haptic feedback to the user. In response to the haptic feedback, the user raises device 100 into viewing position, thereby causing device 100 to display user interface screen 801. Screen 801 includes icons 802-804 representing applications that it has determined as being relevant to the user at the moment. Icon 802 represents the unread SMS message. Icon 803 represents an upcoming calendar event. Icon 804 represents available traffic information. Icon 802 is displayed in large format because the SMS message, which was recently received, ranks highest in relevance.

Because messaging icon 802 has the highest relevance, when the user rotates input mechanism 108 in direction 805, device 100 launches the corresponding messaging application and displays unread SMS message 812 on user interface screen 811. In response to a further rotation of input mechanism 108 in direction 805, device 100 displays calendar event 822 in the calendar application represented by icon 803 on user interface screen 821. In response to a further rotation of input mechanism 108 in direction 805, device 100 displays traffic information provided by the map application (corresponding to icon 804) on user interface screen 831.

From screen 811, a user may tap on SMS message 812 to invoke user interface screen 901, shown in FIG. 9. Turning to FIG. 9, screen 901 includes icon 902 for responding to SMS message 812. Screen 901 also includes icon 903 for creating an alarm at 3 o'clock in the afternoon as suggested by SMS message 812. Similarly, when screen 821 (FIG. 8) is displayed, the user may tap on calendar event 822 to invoke user interface screen 911, shown in FIG. 9. Screen 911 includes icon 912 for messaging an event attendee (e.g., Larry). Screen 911 also includes icon 913 for obtaining navigation to the event location. Finally, when screen 831 (FIG. 8) is displayed, a user may tap on map 832 to invoke user interface screen 921, shown in FIG. 9. Screen 921 includes icon 922 for setting a navigation waypoint and icon 923 for obtaining turn-by-turn navigation instructions.

In some embodiments, device 100 can distinguish between short taps and long taps on touch-screen 104 (FIG. 1), and invoke screen 901 only after a long-tap on screen 811 (FIG. 8), for example. For purposes of this disclosure, a short tap refers to a brief touch on touchscreen 104 (FIG. 1) followed by a release of the touch. A long tap refers to a longer touch on touchscreen 104 (FIG. 1) before touch release. Device 100 can consider touches exceeding a predetermined duration to be long taps (and touches of shorter duration to be short taps). In some embodiments, device 100 can distinguish between the level of pressure on touchscreen 104. That is, device 100 can detect the intensity of a touch object (e.g., a user's finger) on touchscreen 104. Thus, device 100 can invoke screen 901 only after a user taps on screen 811 (FIG. 8.) with sufficient pressure.

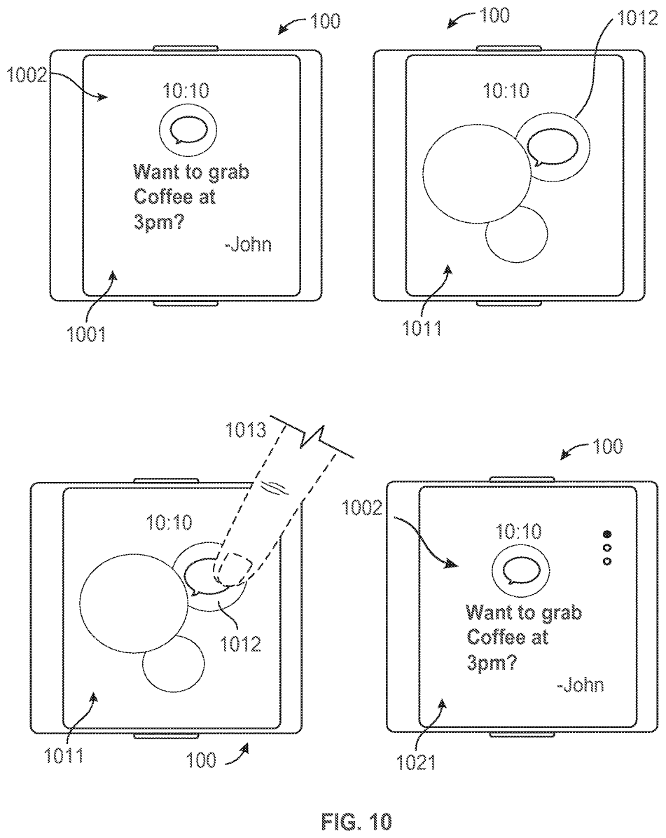

In some embodiments, device 100 can distinguish between brief glances and longer stares at touchscreen 104 (FIG. 1). A brief glance can be characterized by having a short duration between the raising of the device into viewing position and the subsequent lowering of the device. A longer stare can be characterized by a period of relative steadiness of the device in the viewing position. Device 100 can respond to brief glances and longer stares differently. This aspect is illustrated by FIG. 10. In the example of FIG. 10, user interface screen 1001 was displayed in response to a user's movement of device 100 into viewing position. However, instead of displaying multiple relevant user interface objects, user interface screen 1001 emphasizes the display of an unread SMS message 1002 from a contact, because message 1002 had arrived immediately before device 100 was raised into viewing position. If the user maintains device 100 in viewing position exceeding a predetermined time duration, device 100 replaces screen 1001 with user interface screen 1011, which shows multiple icons representing relevant user interface objects available on device 100. From screen 1011, the user can tap on icon 1012 using finger 1013 to return to SMS message 1002. In this way, device 100 permits a user to briefly glance at an incoming message.

### 4. Exemplary User Interfaces

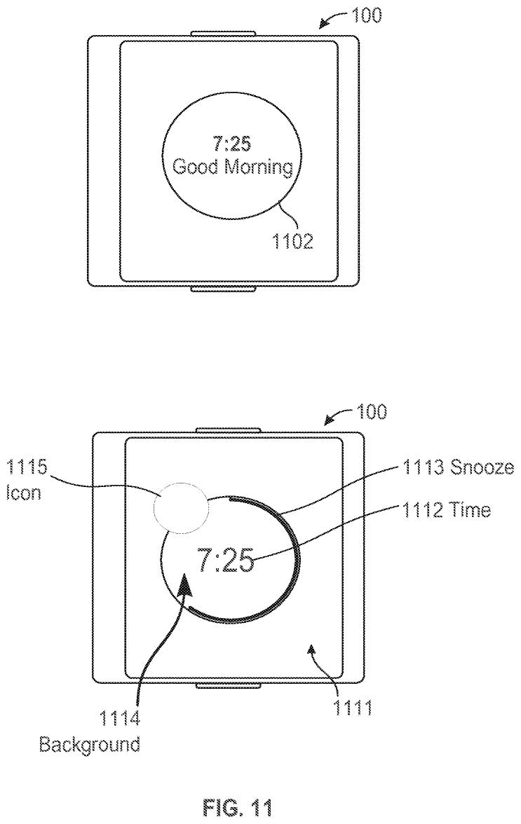

FIGS. 11-16 illustrate exemplary user interfaces that device 100 can display, based on relevance, over the course of a day. In FIG. 11, device 100 determines that the user has recently awakened, and displays an appropriate greeting 1102 stating “good morning”. Device 100 can make this determination based on the time of day, the user's interaction with an alarm clock application (e.g., user may have just turned off an alarm), and/or movement of the device that indicate the user is walking after a sedentary period, for example. Device 100 can rank greeting 1102 as the most relevant icon to be displayed to a user as he wakes up. Because of its high relevance, greeting 1102 is emphasized on user interface screen 1101, meaning that greeting 1102 can be largest icon displayed, or the only icon displayed. Note, however, that when greeting 1102 is the only icon displayed, other non-icon user interface elements (such as the current time) can still be displayed on-screen.

User interface screen 1111 depicts another exemplary user interface that device 100 can display as its user wakes up. Screen 1111 includes icon 1112 indicating the current time. Icon 1123 can have circumferential outline 1113 indicating the time remaining in snooze. Optionally, icon 1112 can have a background that indicates the current weather, for example, with blue representing temperate weather and gray representing inclement weather. Screen 1111 can also include icon 1115 indicating unread messages that the user should attend to.

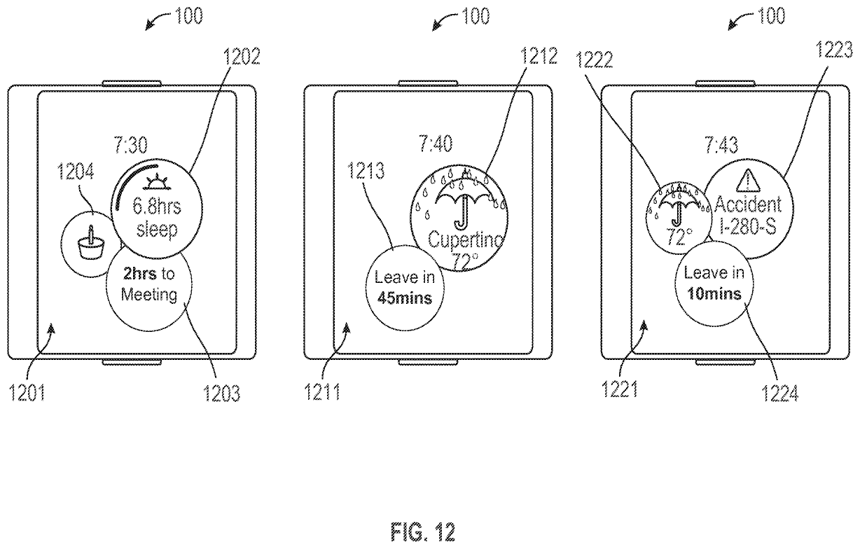

FIG. 12 illustrates user interface screen 1201, which can show additional relevant user interface objects after a user wakes up. Screen 1201 includes relevant icons 1202-1204. Icon 1202 can correspond to a health application and indicate sleep information, such as the duration of sleep by the user. Icon 1203 can correspond to calendar information, such as the remaining time before a next calendar event. Icon 1204 can correspond to additional calendar information, such as all-day events.

User interface screen 1211 depicts additional relevant user interface objects that device 100 can display after a user wakes up. Screen 1211 includes relevant icons 1212 and 1213. Icon 1212 can correspond to a weather application indicating the weather at the device's present location. Optionally, icon 1212 can indicate the weather at a location that the user historically travels to in the morning, such as the weather at the user's work location. In addition, icon 1213 can indicate that the user should begin his morning commute to work in 45 minutes. Device 100 can make this determination based on the first event in today's calendar, the user's usual travel destination on weekday mornings, and the estimated time of travel to that destination based on distance and traffic information, for example.

User interface screen 1221 depicts additional relevant user interface objects that device 100 can display later in the morning. Exemplary user interface screen 1121 includes relevant icons 1222-1224. Icon 1222, which indicates weather condition, can display the same information that was displayed earlier by icon 1212. However, while icon 1212 was the most relevant icon on screen 1211, its relevance in screen 1221 is superseded by traffic icon 1223. Traffic icon 1223 indicates a traffic alert and is displayed as the largest icon because device 100 has determined that information about an accident along the user's typical morning commute is highly relevant at the moment. Screen 1221 also includes icon 1224 indicating that the user should begin his commute to work in 10 minutes, rather than the 45 minute indication given earlier by icon 1213, in view of traffic information (caused by the accident) received by device 100.

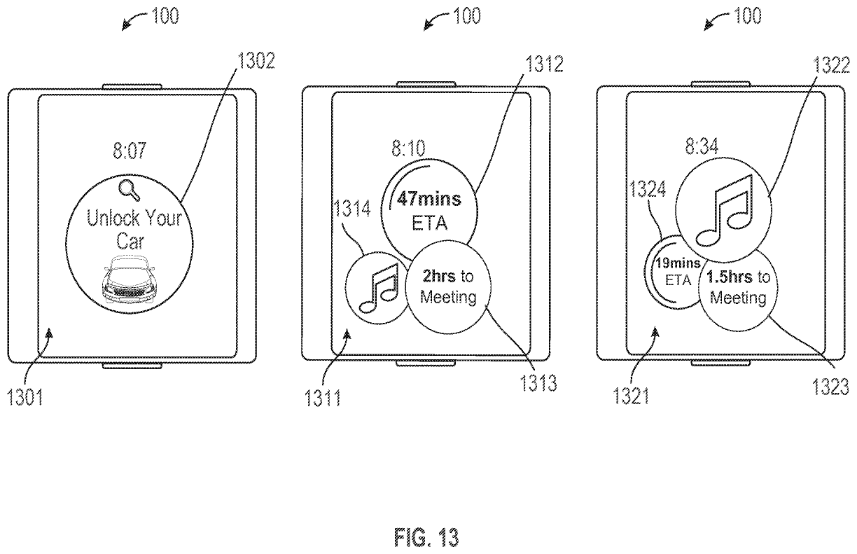

Turning to FIG. 13, screen 1301 depicts icon 1302 for unlocking the user's vehicle as he approaches his vehicle. Device 100 can display icon 1302 based on decreasing distance between device 100 and his nearby vehicle. Optionally, screen 1301 can include additional relevant icons, such as those discussed with respect to FIG. 1. While the user is in his car, device 100 can display user interface screen 1311 if it is raised into viewing position. Screen 1311 includes information about the estimate time to arrival (“ETA”) to work (i.e., icon 1312), the time to his next calendared meeting (i.e., icon 1313), and the music player (i.e., as represented by icon 1314), which are relevant to the user as he is en route to work. Device 100 can determine that the user is driving based on GPS movement and/or by communication with an in-car telematics system (e.g., through Bluetooth™ or a cable connection). Device 100 can determine that the user is driving to his work based on historical information about the user's commute pattern. As the user nears his workplace, the estimated time to arrival may become less relevant, causing the information to be displayed with less emphasis. For example, in user interface screen 1321, music icon 1322 is displayed in larger format than ETA icon 1224. Icon 1323 can continue to display the time to the next calendared meeting as the information continues to be highly relevant. Device 100 can mark the reminder as highly relevant if the meeting is off-site (i.e., physically far from the user's work location), based on GPS sensor and calendar information.

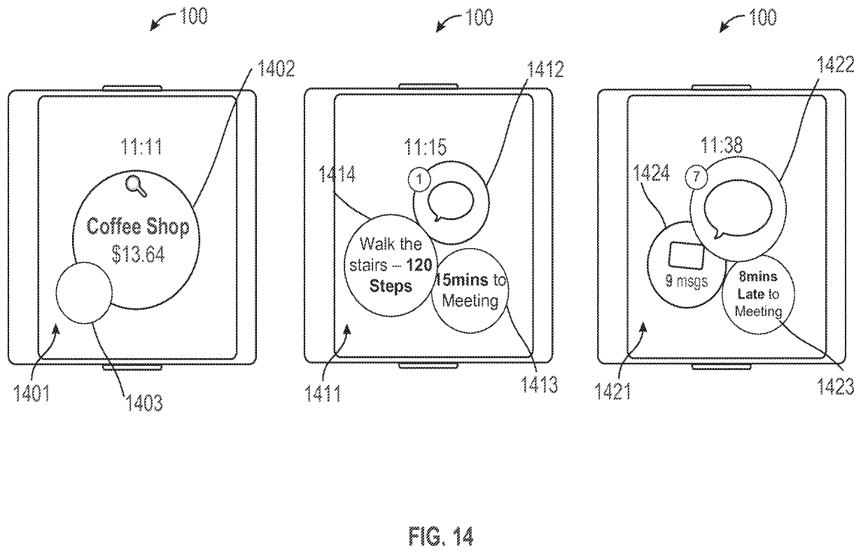

Turning to FIG. 14, later in the day, the user of device 100 can visit a store such as a coffee shop. On screen 1401, device 100 can display an electronic-payment icon 1412 that permits the user to authorize a purchase at the coffee shop. Device 100 can determine its proximity to the coffee shop based on GPS information and application data provided by a map application or a third-party application, such as a Starbucks™ application. Device 100 can also determine its proximity to the coffee shop based on wireless communication with the store's point-of-sale system, such as through near-field communication with a payment reader. In addition, on screen 1401, device 100 can display icon 1403 indicating the proximity of a contact (e.g., a friend) at the coffee shop. On screen 1411, device 100 can display icon 1412 indicating a new incoming message, icon 1413 counting down to an upcoming meeting, and icon 1414 suggesting that the user should take the stairs to the meeting for additional exercise. Device 100 can remind a user if he is late to a meeting. For example, on screen 1421, device 100 can display icon 1422 alerting the user that the user is eight minutes late to a calendared meeting, and icons 1423 and 1424 alerting the user to new incoming messages, some of which may have been triggered by his absence at the meeting.

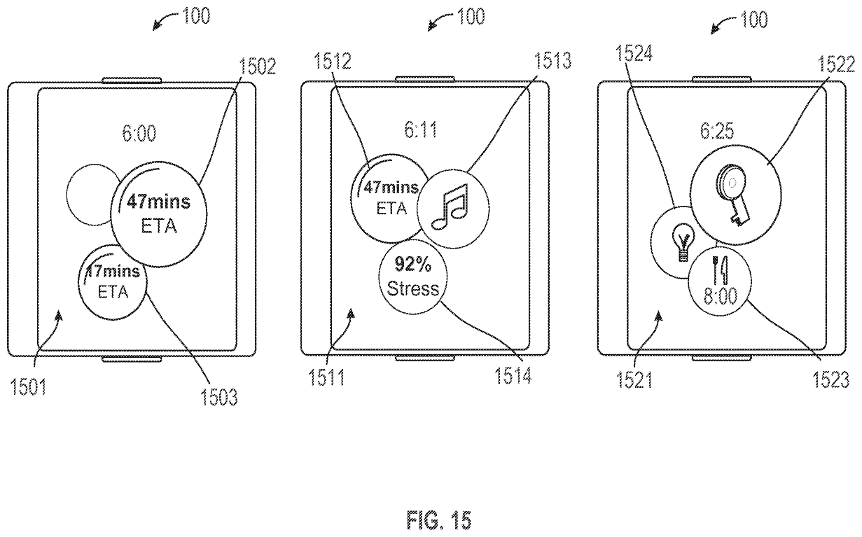

Turning to FIG. 15, device 100 can display information relevant as the workday draws to a close. On user interface screen 1501, device 100 can display the user's ETA to home (i.e., icon 1502) and his spouse's ETA to home (i.e., icon 1503). On user interface screen 1511, device 100 can continue to display the user's ETA to home (i.e., icon 1512), a music application to changing the music in his vehicle (i.e., icon 1513), and a stress level indicator (i.e., icon 1514). Device 100 can calculate the user's stress level based on sensor input including, for example, PPG, ECG, and GSR sensor readings. As the user arrives home and looks at device 100, device 100 can display icon 1522 for unlocking a wireless-enabled front-door door lock. Device 100 can also display icon 1524 for controlling in-home electronics, such as lighting and furnace settings, through Wi-Fi enabled lighting and HVAC controllers. Device 100 can also display icon 1523 indicating a dinner event.

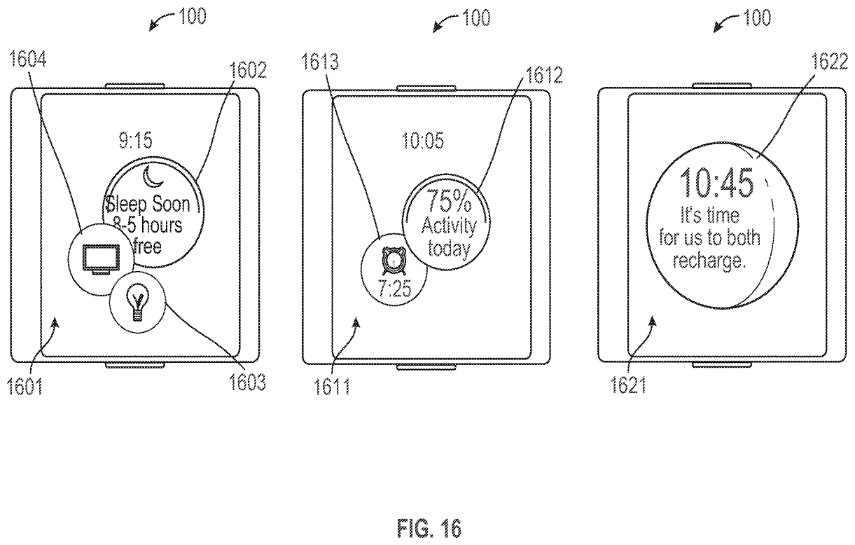

Turning to FIG. 16, device 100 can display information relevant as the day ends. On user interface screen 1601, device 100 can display icon 1602 suggesting that the user should sleep soon, based on the user's usual sleep time and the next morning's calendared activities, for example. Device 100 can also display icon 1604 for controlling televisions, based on the user's habit of watching television at night. Device 100 can also display icon 1603 for lighting control, also based on the user's usual end-of-day routine. As the user's usual bed time continues to draw near, device 100 can display a summary of the user's physical activities for the day (i.e., icon 1612 indicating the user met 75% of their daily goal), and an alarm clock icon 1613 for setting an alarm for the next morning. Device 100 can also reduce the amount of user interface objects displayed at the end of the day. For example, as shown on screen 1621, device 100 can display a single icon 1622 suggesting sleep. In addition, icon 1622 can be displayed using light wavelengths that are less likely to interfere with a user's sleep pattern. In this way, device 100 can avoid keeping its user awake and/or awaking its sleeping user.

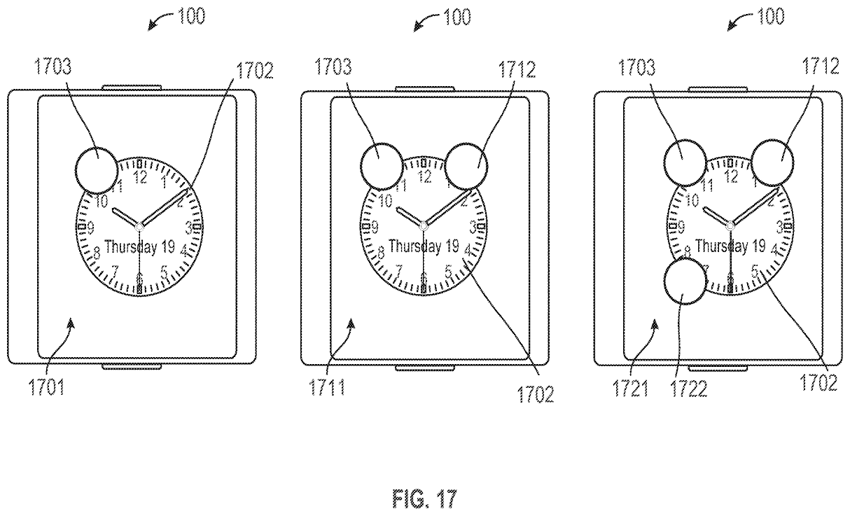

Optionally, device 100 can be configured to display a clock face persistently. This aspect is described with respect to FIG. 17. In the illustrated example, device 100 displays user interface screen 1702 in response to the raising of the device into viewing position. On screen 1702, clock 1702 is displayed together with relevant icon 1703. As device 100 identifies additional relevant user interface objects, they can be displayed in the foreground of touchscreen 104 (FIG. 1) about the circumference of clock 1702, as demonstrated by additional relevant icons 1712 and 1713 on screens 1711 and 1721. In this way, a user can configure device 100 so as to emphasize its time-keeping function.

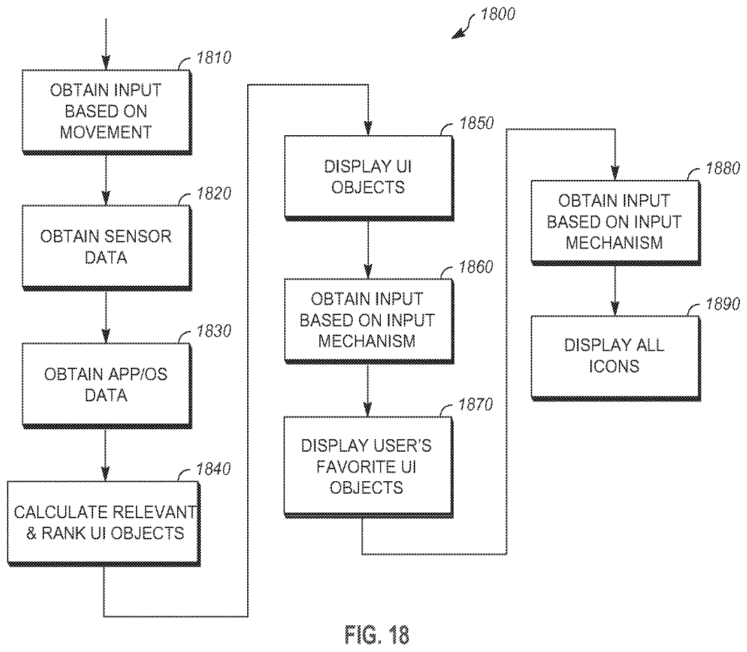

FIG. 18 depicts exemplary process 1800 that can be performed by device 100 to display relevant user interface objects. At block 1810, device 100 obtains input from a movement sensor indicating movement of the device into a viewing position. In some embodiments, the movement can be an upward movement. At block 1820, device 100 obtains additional sensor data. Such sensor data can include GPS location information, lighting information, movement information, and/or accelerometer information. At block 1830, device 100 obtains application or operating system data. Such data can be obtained through a communication channel such as Wi-Fi, Bluetooth™, or NFC. At block 1840, device 100 identifies, based on the sensor data and application/OS data, user interface objects that are relevant for display to the user. Device 100 can also rank the relevant user interface objects. At block 1850, the most relevant user interface objects are displayed to the user. At block 1860, device 100 receives a input representing movement of an input mechanism. In response, at block 1870, device 100 displays icons representing the user's favorite applications available on the device. At block 1880, device 100 receives an additional input representing movement of an input mechanism. In response, at block 1890, device 100 displays icons representing all of the available applications on the device.

Turning back to FIG. 7, memory section 708 of computing system 700 can be a non-transitory computer readable storage medium, for storing computer-executable instructions, which, when executed by one or more computer processors 706, for example, can cause the computer processors to perform the user interface techniques described above, including process 1800 (FIG. 18). The computer-executable instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. For purposes of this document, a “non-transitory computer readable storage medium” can be any medium that can contain or store computer-executable instructions for use by or in connection with the instruction execution system, apparatus, or device. The non-transitory computer readable storage medium can include, but is not limited to, magnetic, optical, and/or semiconductor storages. Examples of such storage include magnetic disks, optical discs based on CD, DVD, or Blu-ray technologies, as well as RAM, ROM, EPROM, flash memory, and solid-state memory. Computing system 700 is not limited to the components and configuration of FIG. 7, but can include other or additional components in multiple configurations.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the appended claims.

What is claimed is:

1. A computer system comprising:
a rotatable input mechanism;
a display device;
one or more processors; and
memory storing one or more programs configured to be executed by the one or more processors, the one or more programs including instructions for:
displaying, via the display device, a user interface including a plurality of application icons;
while displaying the user interface including the plurality of application icons, detecting rotation of the rotatable input mechanism; and
in response to detecting the rotation of the rotatable input mechanism, replacing display of the user interface including the plurality of application icons with a representation of a physical location.

2. The computer system of claim 1, wherein the representation of the physical location includes a map.

3. The computer system of claim 1, wherein the representation of the physical location includes traffic information.

4. The computer system of claim 1, wherein the one or more programs further include instructions for:
detecting a second input directed to the representation of the physical location; and
in response to detecting the second input directed to the representation of the physical location, displaying, via the display device, a plurality of options associated with the physical location.

5. A non-transitory computer-readable storage medium storing one or more programs configured to be executed by one or more processors of a computer system with a rotatable input mechanism and a display device, the one or more programs including instructions for:
displaying, via the display device, a user interface including a plurality of application icons;
while displaying the user interface including the plurality of application icons, detecting rotation of the rotatable input mechanism; and
in response to detecting the rotation of the rotatable input mechanism, replacing display of the user interface including the plurality of application icons with a representation of a physical location.

6. The non-transitory computer-readable storage medium of claim 5, wherein the representation of the physical location includes a map.

7. The non-transitory computer-readable storage medium of claim 5, wherein the representation of the physical location includes traffic information.

8. The non-transitory computer-readable storage medium of claim 5, wherein the one or more programs further include instructions for:
detecting a second input directed to the representation of the physical location; and
in response to detecting the second input directed to the representation of the physical location, displaying, via the display device, a plurality of options associated with the physical location.

9. A method, comprising:
at a computer system with a rotatable input mechanism and a display device:
displaying, via the display device, a user interface including a plurality of application icons;
while displaying the user interface including the plurality of application icons, detecting rotation of the rotatable input mechanism; and
in response to detecting the rotation of the rotatable input mechanism, replacing display of the user interface including the plurality of application icons with a representation of a physical location.

10. The method of claim 9, wherein the representation of the physical location includes a map.

11. The method of claim 9, wherein the representation of the physical location includes traffic information.

12. The method of claim 9, further comprising:
detecting a second input directed to the representation of the physical location; and
in response to detecting the second input directed to the representation of the physical location, displaying, via the display device, a plurality of options associated with the physical location.
